(19) United States
(12) Patent Application Publication
(10) Pub. No.: US 2019/0031507 A1
(43) Pub. Date: Jan. 31, 2019

(54) METHOD AND SYSTEM FOR OXYGEN PRODUCTION AND ENERGY STORAGE

(71) Applicant: Infratech Industries Pty Ltd, Burwood, New South Wales (AU)

(72) Inventors: Behdad MOGHTADERI, Callaghan, New South Wales (AU); Kalpit SHAH, Callaghan, New South Wales (AU)

(73) Assignee: Infratech Industries Pty Ltd, Burwood, New South Wales (AU)

(21) Appl. No.: 16/073,206

(22) PCT Filed: Jan. 24, 2017
(86) PCT No.: PCT/AU2017/050054

§ 371 Date: Jul. 26, 2018

(30) Foreign Application Priority Data
Jan. 25, 2016 (AU) 2016900222

(51) Int. Cl. C01B 13/08; C01B 13/02; B01D 53/26; F23L 7/00; F23C 10/01

(52) U.S. Cl. CPC C01B 13/08; C01B 13/0248; B01D 53/265; F23C 2202/00; F23C 10/01; C01B 2210/0009; F23C 2900/99008; F23L 7/007

(57) ABSTRACT

The present invention provides a method and system (1) for producing oxygen. Oxygen-carrier particles are transferred between a reduction process (10) and an oxidation process (15) connected to form a chemical looping process. The reduction process produces oxygen-depleted carrier particles and an exhaust gas mixture. Oxygen is separated from the exhaust gas mixture, preferably by a condenser (5). The oxygen-depleted carrier particles are returned to the oxidation process for regenerating the oxygen-depleted carrier particles with oxygen. The reduction process is performed during a first time period and the oxidation process is performed in a second time period.

### CROSS-REFERENCE TO PRIORITY APPLICATION

The present application claims priority to Australian Provisional Patent Application No. 2016900222, whose specification as filed is hereby incorporated by reference in its entirety.

### FIELD OF THE INVENTION

The present invention relates to a method and system for producing oxygen and in particular relates to a chemical looping-based oxygen production and energy storage method and system. The invention has been developed primarily for the production of oxygen and storage of energy for industrial and medical applications, especially coal-fired power plants.

### BACKGROUND TO THE INVENTION

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Oxygen is the second most widely used industrial gas after nitrogen. Worldwide industrial oxygen production capacity rose from 0.75 to 2 million tonnes per day (tpd) from 1996 to 2015. The global oxygen production market has maintained a steady 5-6 percent growth over the last two decades. Thermal oxidation with molecular oxygen is among the most important reaction types in various process industries, including chemical processes employing various types of oxygen enrichment, combustion and reduction processes, the petroleum refinery sector, healthcare industries, the steel industry, glass furnaces and cement kilns. For example, oxygen has many important uses within the steel industry, including the heating and melting of metals using oxygen enrichment in blast furnaces, basic oxygen furnaces and electric arc furnaces. Similar to the steel industry, cement kilns and glass furnace also require oxygen enrichment. Some of the advantages of oxygen enrichment in the steel, cement and glass industries include increased capacity; capital cost savings; operational flexibility (through the utilisation of waste fuel streams); operational reliability; improved conversion, reduced emissions and CO₂ capture options; gas impurity destruction; quick solution and a compact footprint.

The predominant oxidant for thermal oxidation processes is air. However, air has a rather limited oxygen content (21 volume %) and a high proportion of inert nitrogen. Inevitably, air sent through the process generates high off-gas volumes. This drawback can be overcome by adding oxygen to the process air-especially when combined with a reduction of the air flow; i.e. a reduction in the nitrogen load. Such an additional use of oxygen is applied for the intensification of many oxidation processes. This oxidation intensification confer benefits in the potential productivity enhancement, which in many cases can be combined with advantages in operation, and often includes mitigating environmental impacts by industrial processes. Oxygen enrichment in the abovementioned process industries is generally of three main types:
Pure oxygen injection (examples include basic oxygen furnaces and healthcare);
Oxygen enrichment in air (examples include a glass industry furnace); and
Oxygen enrichment in CO₂ (examples include a cement kiln).

While conventional cryogenic air separation methods may be considered as matured technologies for producing high purity oxygen for the abovementioned applications, their energy intensity and high capital and operating costs can no longer be tolerated under the current economic, energy, and environmental constraints. For example, a conventional cryogenic air separation unit may have extremely high energy requirements i.e. ˜0.4 kWh per cubic metre of O₂ and higher capital investment. Advanced membrane (e.g. ion-transport membrane) and adsorption (e.g. nano-structured molecular sieves) systems could replace cryogenic plants to some extent, but this technology is still emergent and thus unproven.

There is also increasing penetration of intermittent energy sources (e.g. wind and solar) into electricity networks coupled with changes in power consumption patterns due to demand-side management, electricity deregulation and smart grids, generally favour low cost power plants that have the ability to cycle on and off depending on load variations. Cycling here refers to the operation of generating units at different load levels in response to changes in network load requirements. These include, on/off, load following, and minimum load operation. Gas turbine power plants have been traditionally used in electricity networks to deal with load variations (particularly during peak hours) although these plants are generally very expensive to run.

Competition has also forced many coal-fired power plant operators and utilities to adopt unit cycling of their asset which quite often are aging hardware. This type of cycling would have onerous effects on conventional coal-fired power plants given that such systems have been principally designed for baseload operations with a small number of start-ups and shut-downs per year. Cycling does particularly damage the coal-fired units of the plant (often due to unavoidable thermal and pressure stresses) increasing their failure rates thereby lowering their life expectancies compared to baseload operations. More importantly the suboptimal operation of coal-fired units during cycling will inevitably lead to efficiency losses and, hence, higher greenhouse gas (GHG) emissions.

While operational changes such as modifications to operational practices, proactive inspections and extensive training can reduce the extent of damage and lower the cost of maintenance, the detrimental impact of cycling cannot be fully eliminated by this approach. Upgrading of the plant to a combined cycle configuration also does not completely resolve the issue since even modern combined cycle plants experience difficulties when cycling under variable load.

Given the considerable work that has been undertaken in recent years to resolve the issues associated with unit cycling, any further work based on relatively standard approaches might be difficult to justify.

Hence, it is an object of the present invention to overcome or ameliorate at least one of the disadvantages of the prior art, or to provide a useful alternative. It is an object of at least one embodiment of the invention to provide a more efficient and economic means of producing oxygen for industrial applications.

### SUMMARY OF THE INVENTION

The present invention thus provides a method for producing oxygen, comprising: transferring oxygen-carrier particles between a reduction process and an oxidation process connected to form a chemical looping process; wherein the reduction process produces oxygen-depleted carrier particles and an exhaust gas mixture comprising oxygen; removing the exhaust gas mixture from the reduction process; separating oxygen from the exhaust gas mixture; and returning the oxygen-depleted carrier particles to the oxidation process for regenerating the oxygen-depleted carrier particles with oxygen; wherein the reduction process is performed during a first time period and the oxidation process is performed in a second time period.

Preferably, the first time period comprises a day phase. More preferably, the day phase comprises a 12-hour period. In one embodiment, the day phase comprises a 15-hour period.

Preferably, the first time period comprises a peak oxygen-demand period.

Preferably, the first time period comprises a peak energy demand period.

Preferably, the second time period comprises a night phase. More preferably, the night phase comprises a 9-hour period. In one embodiment, the night phase comprises a 12-hour period.

Preferably, the second time period comprises an off-peak oxygen-demand period.

Preferably, the second time period comprises an off-peak energy demand period.

Preferably, the method comprises adding an oxygen-containing gas to the oxidation process to enrich the oxygen-depleted carrier particles with oxygen. More preferably, the oxygen-containing gas is air.

Preferably, the separating step comprises condensing the oxygen from the exhaust gas mixture. More preferably, condensation of the oxygen from the exhaust gas mixture produces water for recycling.

Preferably, the oxidation and reduction processes occur within one reactor. More preferably, the reactor comprises a fluidised bed reactor.

Alternatively, the oxidation process occurs in an oxidation reactor and the reduction process occurs within a reduction reactor, where the oxidation reactor and the reduction reactor are fluidly connected to form the chemical looping process.

Preferably, the exhaust gas mixture comprises carbon dioxide and/or flue gas.

Preferably, the oxygen depleted air from the oxidation process is passed through a heat exchanger to transfer heat to the oxygen-containing gas added to the oxidation process.

Preferably, the exhaust gas mixture from the reduction process is passed through a heat exchanger to transfer heat to a fuel for the reduction process.

Preferably, a fluid medium is passed through a heat exchanger to receive heat from the chemical looping process and drive a turbine. More preferably, the fluid medium comprises water and steam is generated to drive the turbine to generate electricity. Alternatively, the fluid medium is directed to a temperature control system for heating or cooling.

Preferably, the oxygen separated from the exhaust gas mixture is transferred to an oxygen consumption unit.

Preferably, the oxygen-carrier particles comprise metal oxides. More preferably, the metal oxides comprise at least one of Cu, Mn and Co based metal oxides. In one embodiment, the metal oxides comprise mono-bi-metallic oxide sorbents or composites, such as perovkites and the like. In other embodiments, the metal oxides are selected from the group comprising MnO₂, Mn₂O₃, Mn₃O₄, CoO, Co₃O₄, CuO, Cu₂O and mixed metal oxides.

In another aspect, the invention provides the use of a reactor in the method of the first aspect of the invention.

According to a further aspect of the invention there is provided a system for producing oxygen, comprising one or more reactors for performing an oxidation process and a reduction process connected to form a chemical looping process, wherein the reduction process produces oxygen-depleted carrier particles and an exhaust gas mixture comprising oxygen; a conduit for removing the exhaust gas mixture from the reactor; a oxygen separating unit for separating oxygen from the exhaust gas mixture; wherein the one or more reactors are configured to perform the reduction process during a first time period and perform the oxidation process in a second time period.

The system preferably comprises a heat exchanger for exchanging heat between the exhaust gas mixture and incoming gas into the reactor for the reduction process.

Preferably, the system comprises a heat exchanger for exchanging heat between air from an air supply and oxygen depleted air from the reactor generated by the oxidation process.

Preferably, the system comprises a reservoir for storing the oxygen from the oxygen separating unit. More preferably, the reservoir controllably releases oxygen to a combustion unit. In one embodiment, the reservoir has a valve to controllably release oxygen.

Preferably, the combustion unit combusts coal in a coal-fired power plant. In some embodiments, the combustion unit comprises a furnace. In other embodiments, the combustion unit comprises a boiler.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

Preferred embodiments of the invention will now be described, by way of example only, with reference to the drawings of which:

FIG. 1 is a schematic drawing of an apparatus for an intermittent chemical looping energy storage and oxygen production (CL-ESOP) process according to one embodiment of the invention;

FIG. 2 is a schematic drawing of a process simulation of the intermittent CL-ESOP process of FIG. 1;

FIG. 3 is a schematic drawing of a continuous CL-ESOP process for the apparatus according another embodiment of the invention;

FIG. 4 is a schematic drawing of a continuous CL-ESOP process developed for a melting glass furnace according to a further embodiment of the invention;

FIG. 5 is a schematic drawing of a continuous CL-ESOP process developed for cement kiln operations according to yet another embodiment of the invention;

FIG. 6 is a schematic drawing of the operating cycle of a preferred embodiment of the invention;

FIGS. 7A and 7B are schematic drawings of the intermittent CL-ESOP process according to yet another embodiment of the invention operating in a unique pressure-temperature swing mode;

FIG. 8 is a schematic drawing of the apparatus of FIG. 7 operating in a night phase in a system according to a preferred embodiment of the invention; and

FIG. 9 is a schematic drawing of the apparatus of FIG. 7 operating in a day phase in the system of FIG. 8.

### DETAILED DESCRIPTION OF PREFERRED EMBODIMENTS

The present invention will now be described with reference to the following examples which should be considered in all respects as illustrative and non-restrictive. In the Figures, corresponding features within the same embodiment or common to different embodiments have been given the same reference numerals.

The invention has been developed for oxygen production and energy storage by applying principles of a chemical looping air separation (CLAS) that has been previously developed by the inventors. CLAS relies on a chemical loop between an oxidation process and a reduction process, an example of which is set out below using a metal oxide as the carrier particles that cycle between the oxidation and reduction processes:

MeₓO_{y}−2(s)+O₂(g) −7MeₓO_{y}(s) Oxidation (1)

MeₓO_{y}(s)−7MeₓO_{y}−2(s)+O₂(g) Reduction (2)

In particular, two versions of this process have been developed; one being an intermittent chemical looping energy storage and oxygen production (CL-ESOP) process and the other being a continuous CL-ESOP process. As indicated by their names, the CL-ESOP process is the same for both versions but operated on either an intermittent or continuous basis.

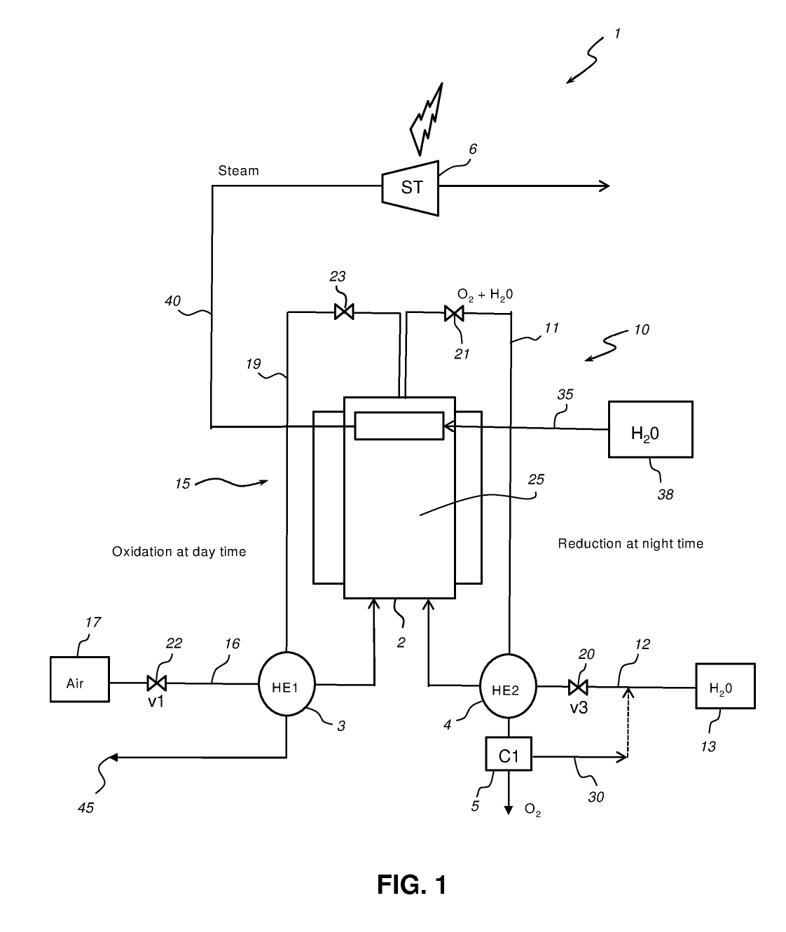

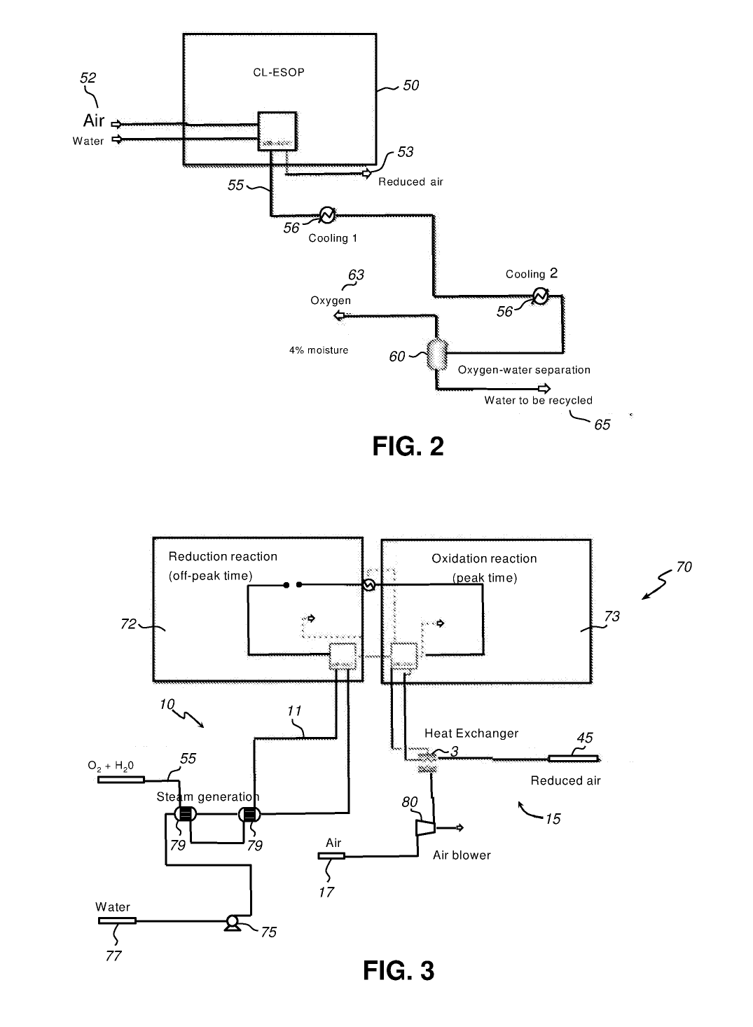

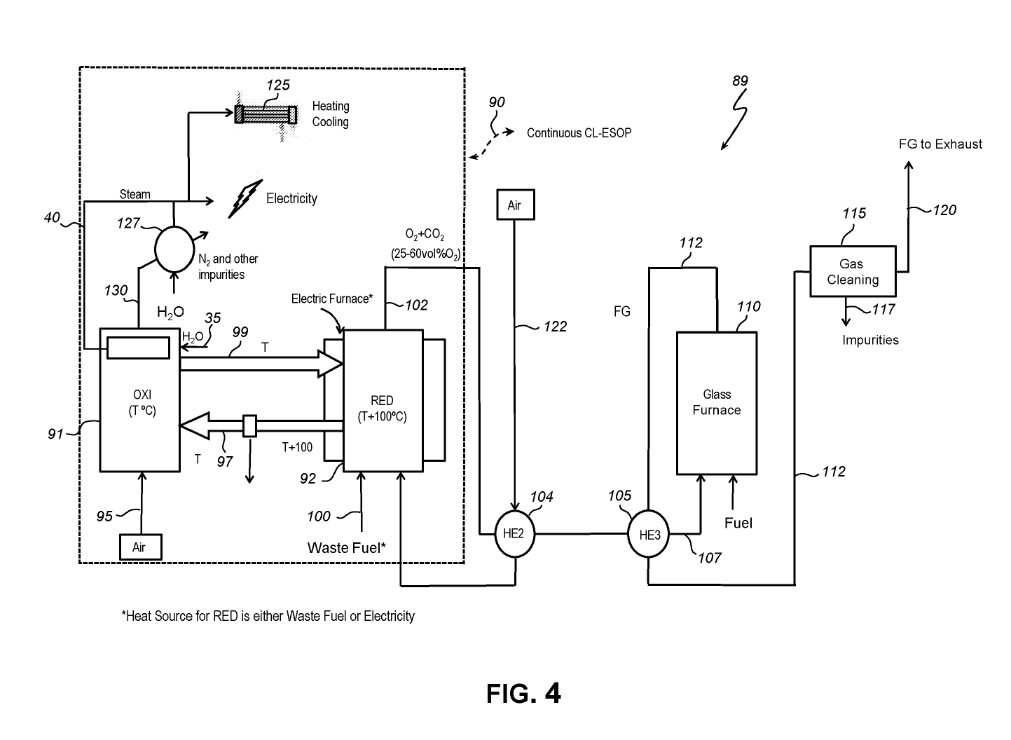

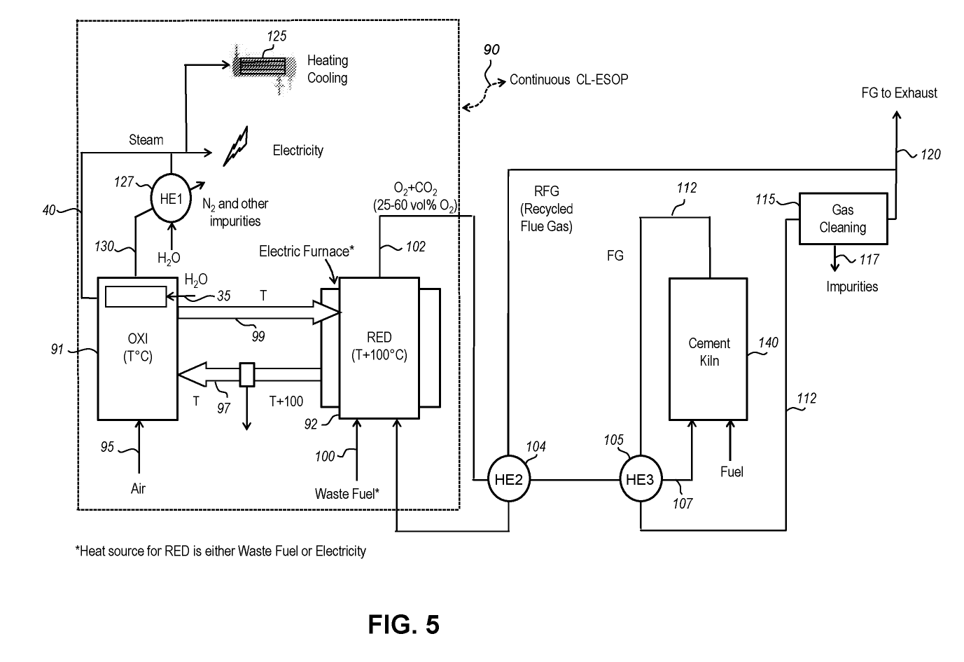

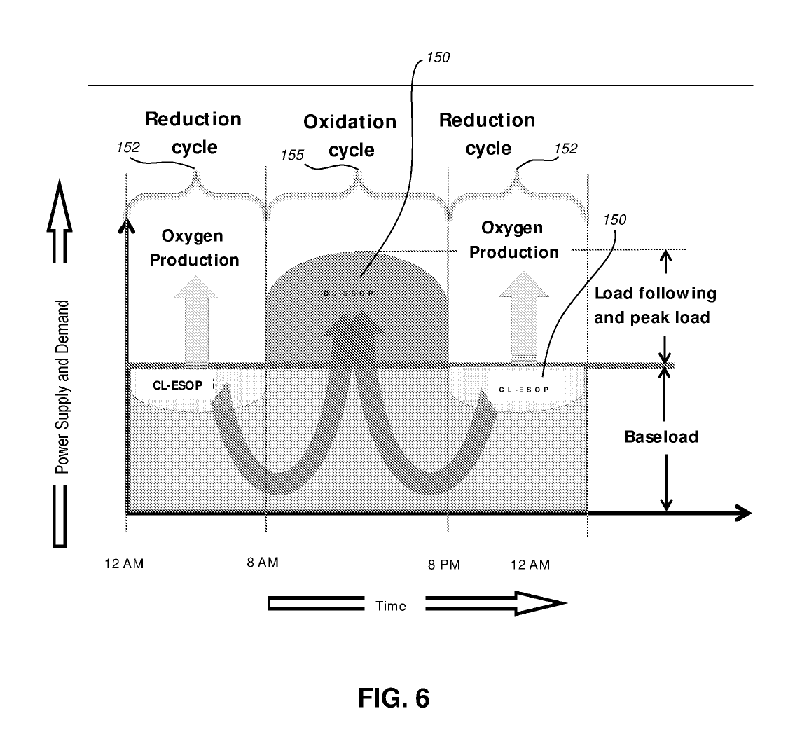

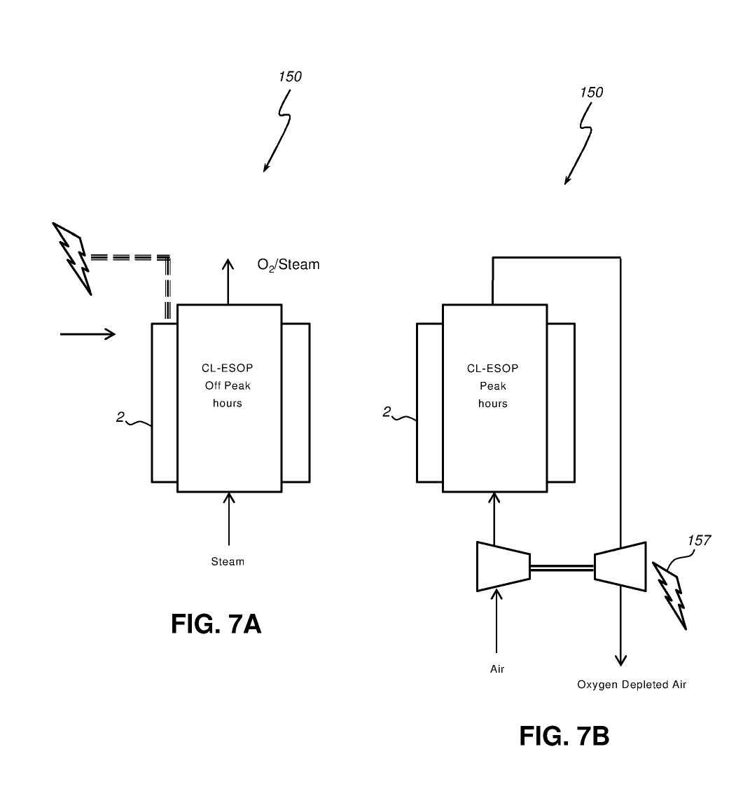

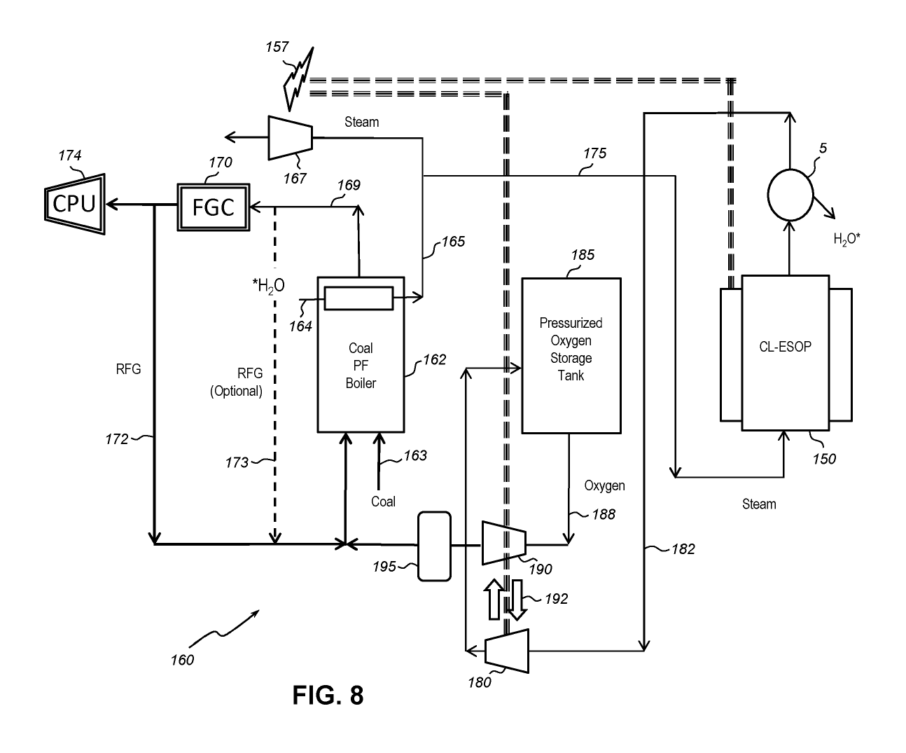

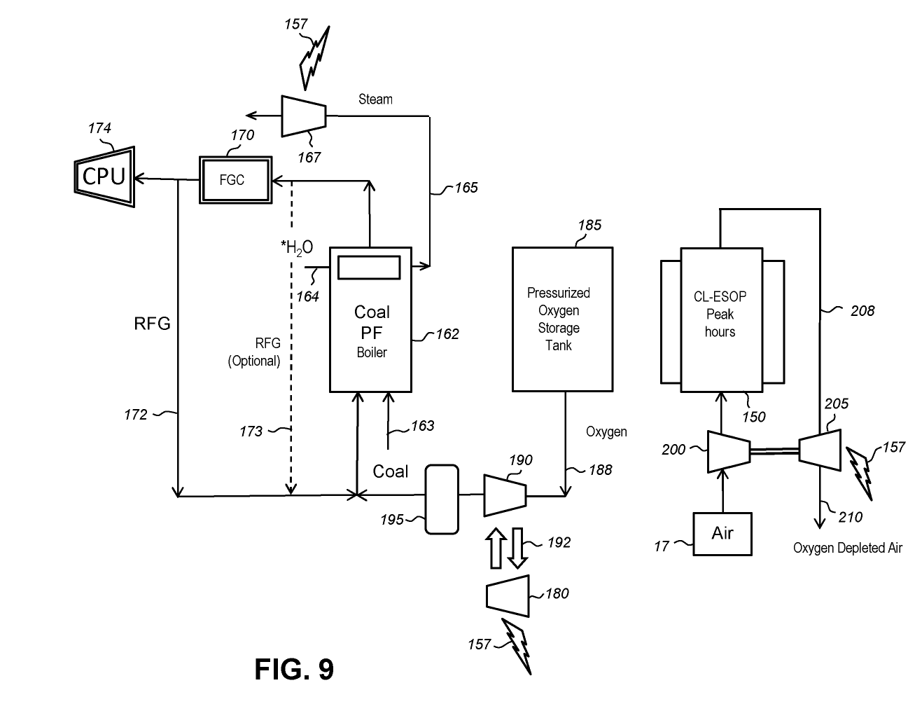

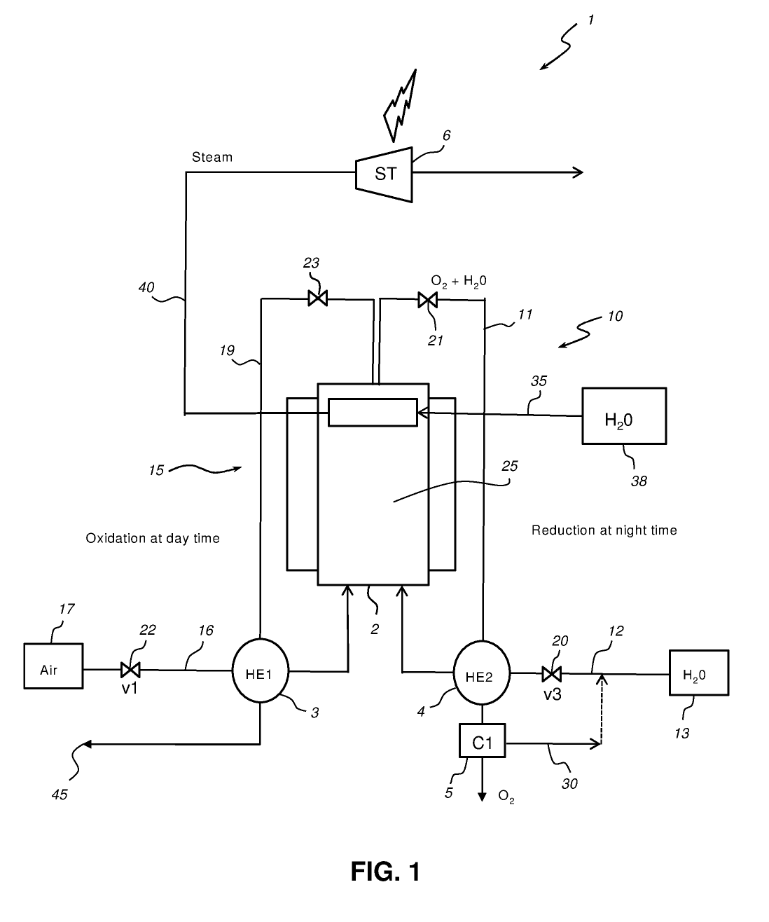

Referring to FIG. 1, an embodiment of the invention is illustrated, where a chemical looping-based oxygen production method and system has been developed mainly to generate oxygen for oxygen producers and/or consumers (for example, hospitals, steelmaking factories and gas companies) as an intermittent CL-ESOP process. In addition, the method and system can be used to store energy in terms of thermal energy or off-peak electricity to be subsequently used during the peak periods of demand for electricity. .

In FIG. 1, an apparatus 1 implementing the intermittent CL-ESOP method comprises a reactor 2 fluidly connected to heat exchangers 3, 4, a condenser 5 and a steam turbine 6. A reduction loop 10 is formed by a conduit 11 connecting the reactor 2 to the heat exchanger 4 and condenser 5, and a conduit 12 connected the reactor 2 to an input gas supply 13 described in more detail below. An oxidation loop 15 is formed by a conduit 16 connecting the reactor 2 to the heat exchanger 3 and an air supply 17, and a conduit 18 connecting the reactor 2 to a discharge conduit 19. Valves 20, 21 close off the reduction loop 10 from the reactor 2 while valves 22, 23 close off the oxidation loop 15 from the reactor. In this way, the reactor 2 can be operated to performed oxidation or reduction separately. Moreover, the oxidation process is performed continuously whenever the oxidation loop 15 formed or opened and the reduction loop 10 is closed off. Likewise, the reduction process is performed continuously whenever the reduction loop 10 is opened and the oxidation loop 15 is closed off.

In the intermittent CL-ESOP method, the reduction loop 10 is formed by closing valves 22, 23 to seal off the oxidation loop 15 and opening valves 20, 21 to enable gas to flow through the conduits 11, 12. The reduction loop 10 is operated during the off-peak hours of electricity usage (i.e. at night time), where the metal oxide oxygen carrier particles in the fluidised bed 25 undergo a reduction reaction in the presence of the input gas, which in this case is a sweep gas added via the conduit 13 from the gas source supply 12. The sweep gas in this case is H₂O, but in other embodiments, the sweep gas can be any inert gas (examples may include CO₂, argon or helium) that can be easily separated by membrane or any separation method after the reduction step to produce pure oxygen stream. The reduction process consumes relatively cheap electricity (or thermal energy originating from carbon-based fuels) using an electric heater or boiler and produces an oxygen-enriched stream primarily containing oxygen and water that passes from the reactor 2 through the conduit 11 and valve 21 to the heat exchanger 4. In the heat exchanger 4, waste heat from the stream is recycled to preheat the incoming water before it is fed into the reactor 2. The produced oxygen is purified from the oxygen-enriched stream by the condenser 5, which condenses the oxygen-enriched stream to separate oxygen from water and thus producing pure oxygen. The pure oxygen is then sent for downstream use and/or storage. The condensate comprising mostly of water is then recycled from the condenser 5 via a conduit 30 back to the reduction loop 10 by joining the incoming water in the conduit 12, through the valve 20 and heat exchanger 4, and then to the reactor 2.

The apparatus 1 is then moved to the oxidation process by closing the valves 20, 21 and opening valves 22, 23 to form the oxidation loop 15. The oxidation process in the oxidation loop 15 is performed during the peak hours (i.e. at day time), where the reduced metal oxide oxygen carrier particles in the fluidised bed 9 are now oxidised in the presence of air which is introduced by the valve 22 from the air supply 17. The air is preheated by a waste stream conveyed by the discharge conduit 19 via the heat exchanger 3. The oxidation process in the reactor 2 generates heat that can be extracted by different ways such as gas (steam or air), liquid (organic or inorganic) and solids (sand or ceramic). For example, in the embodiment, heat is extracted by using a separate conduit 35 carrying water from a water supply 38 to embedded water tubes (not shown) in the reactor 2 to produce hot water or steam for heat and/or power generation purposes. The hot water or steam is directed to the turbine 6 via a conduit 40 to produce electricity. The oxygen depleted air (also called reduced air) comprising mostly of nitrogen is removed from the reactor 2 as the waste stream via the discharge conduit 19. The waste stream passes through the heat exchanger 3 to preheat the incoming air and then is discharged to the ambient environment through an outlet 45.

As indicated above, the CL-ESOP method and apparatus 1 uses metal oxide particles in the form of CoO/Co₃O₄ and CuO/Cu₂O as the oxygen carrier particles. It will be appreciated that in other embodiments, the CL-ESOP process (intermittent or continuous) uses a variety of other suitable oxygen carrier particles such as MnO₂/Mn₂O₃/Mn₃O₄ and mixed metal oxides.

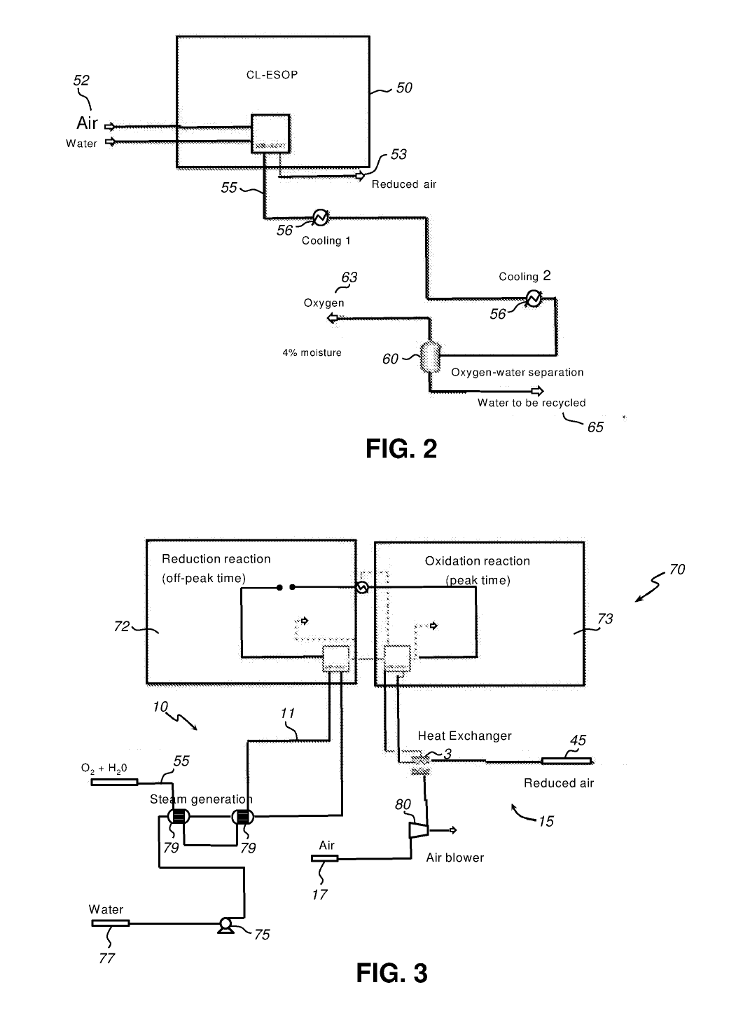

FIG. 2 shows the overall processes involved with the intermittent CL-ESOP method, where the CLAS process 50 receives air and water as inputs 52 and produces reduced (oxygen depleted) air 53 and an oxygen enriched stream 55 that passes through two cooling stages 56, 57 (to exchange heat with the incoming air and water) before undergoing oxygen separation at 60. The pure oxygen produced at 63 is then sent for use in either industrial or medical applications while the water that remains is recycled at 65.

Referring to FIG. 3, another exemplary CL-ESOP unit 70 is illustrated and comprises a modular unit having separate reduction and oxidation reactors 72, 73. In the reduction loop 10, the water is pumped into the reactor 72 via a pump 75 from a water supply source 77 and heat exchangers 79 are used to generate steam from the oxygen enriched stream 55 for power generation prior to being sent to the condenser or other oxygen separation unit. In this embodiment, the CL-ESOP unit 70 is used in a continuous CL-ESOP process, where the mineral/metal oxide particles are transferred between the reduction and oxidation reactors 72, 73. In the oxidation loop 15, air from the air supply 17 is passed through an air blower 80 before passing through the heat exchanger 3 for preheating before entering the oxidation reactor 73. Oxygen depleted air is removed via outlet 45. The reactors 72, 73 are connected to pass the oxygen carrier particles as described above between each other to create the chemical looping process.

The CL-ESOP unit 70 of FIG. 3 is capable of generating 50 m³/hr of oxygen during the period in which the reduction process is performed within the reduction reactor 72 of the unit. During the period in which the oxidation process is performed, no oxygen is produced by the oxidation reactor 73 in the CL-ESOP unit 70. Rather, the oxidation process enriches the oxygen-depleted carrier particles with oxygen for subsequent use in the reduction process. It was estimated that for sustaining an continuous oxygen supply of 50 m³/hr over 24 hours the cyclic operation of the CL-ESOP unit 70 would require at least 2.7 standard CL-ESOP units to be built and operating during the 9 hour off-peak period (approximately from 10 pm to 7 am in the night phase) to be able to produce enough oxygen (i.e. a total of 1,200 m³) for a full day load. Of this amount of produced oxygen, 450 m³ is consumed during the same off-peak period while the rest (being 750 m³) is stored in an oxygen tank (not shown) and consumed during the next 15 hour peak period (during the day phase), all at a constant consumption rate of 50 m³/hr. It is contemplated that this arrangement of 2.67 standard CL-ESOP units is capable of meeting the oxygen requirements of a full-functioning medical hospital having over 500 beds or a steelmaking plant for producing 1 tonne/hr of steel.

Table 1 shows the operating conditions, material requirements, energy demands, and energy and oxygen production for the standard CL-ESOP unit 70 using CuO as the oxygen carrier particles. These parameters are shown for three different reduction reaction temperatures, namely 1040° C., 1077° C., and 1102° C., which correspond to low (25%), medium (50%), and high (75%) levels of oxygen partial pressures of the product stream (i.e. the oxygen enriched stream). It can be seen in Table 1 that as the oxygen partial pressure increases from 25% to 75% the minimum water requirement of the CL-ESOP process is reduced significantly from 103 kg/hr to 12 kg/hr (or by 88%). This reduced water consumption not only helps efficient use of water but more importantly leads to a reduced energy penalty associated with steam generation and hence results in a reduced process heating demand (by up to 28%). Moreover, the cooling demand for oxygen-water separation process is also greatly reduced by up to 88%. It thus suggests a higher oxygen partial pressure is preferable in the operation of the CL-ESOP unit 70, although the oxygen partial pressure should be determined after considering the maximum allowable operating temperature of the reactor 2 and its materials. For instance, the reduction reactor temperature at 1102° C. for achieving an oxygen partial pressure of 75% would be considered to be too high for copper-based oxygen carriers due to a high potential in the occurrence of sintering/aggregation issues.

The oxygen production of the process was found to be around 50 m³/hr with an oxygen purity of 96%. The oxygen purity can be increased further to 99.9% depending on the targeted applications via enhancing the oxygen-water separation process and other oxygen purification processes.

TABLE 1
Technical parameters of the standard CL-ESOP unit using CuO as the oxygen carriers

| Parameters | Items | Units | Value | Value | Value |
|---|---|---|---|---|---|
| Operating | Oxygen partial pressure during | | 0.25 | 0.50 | 0.75 |
| conditions | the reduction reaction | | | | |
| | Reduction reaction temperature | ° C. | 1040 | 1077 | 1102 |
| | Oxygen partial pressure during | | 0.05 | 0.05 | 0.05 |
| | the oxidation reaction | | | | |
| | Oxidation reaction temperature | ° C. | 950 | 950 | 950 |
| Material | Minimum required water flow | kg/hr | 103 | 34 | 12 |
| requirements | Minimum required air flow | kg/hr | 323 | 323 | 323 |
| | CuO inventory | kg/hr | 615 | 615 | 615 |
| Energy | Heating demand of the | kWₜₕ | 181 | 135 | 130 |
| demands | reduction reaction | | | | |
| | Pump power consumption | kW | 0.0009 | 0.0003 | 0.0001 |
| | Compressor power | kW | 2.3 | 2.3 | 2.3 |
| | consumption | | | | |
| | Condenser cooling demand^{#} | kWₜₕ | 67 | 23 | 8 |
| Energy | Heat generation of the oxidation | kWₜₕ | 112 | 111 | 110 |
| generation | reaction | | | | |
| and oxygen | Oxygen flow | m³/hr | 50.0 | 50.1 | 50.2 |
| production | Oxygen purity | | 0.96 | 0.96 | 0.96 |

^{#}Potential heat recovery points

Similarly, Table 2 below sets out the main technical parameters where the standard CL-ESOP unit 70 uses CoO as the oxygen carrier particle. The parameters were determined using the same levels of oxygen partial pressures as those in Table 1 above but at lower temperatures, namely 894° C., 913° C., and 925° C. From Table 2, it can be seen that the minimum water and air requirements as well as the later cooling demand requirements for oxygen-water separation are almost the same as those of the copper case in Table 1 above. This is exactly because the two cases share the same oxygen partial pressure in the production (oxygen enriched) stream along with the same oxygen production rate. However, the minimum required inventory of cobalt oxide is 51% greater than that of copper oxide given the same oxygen storage/production capacity. The heating demand of the reduction reaction for the cobalt oxygen carriers is also greater than the heating demand on the reduction process for copper oxygen carriers. In any event, for both cases the heat consumed, or more properly, stored during the off-peak period will be released during the peak period in the form of high-, medium-, and low-grade heat.

TABLE 2
Technical analysis of the standard CL-ESOP unit using CoO as the oxygen carriers.

| Parameters | Items | Units | Value | Value | Value |
|---|---|---|---|---|---|
| Operating | Oxygen partial pressure during | | 0.25 | 0.50 | 0.75 |
| conditions | the reduction reaction | | | | |
| | Reduction reaction temperature | ° C. | 894 | 913 | 925 |
| | Oxygen partial pressure during | | 0.05 | 0.05 | 0.05 |
| | the oxidation reaction | | | | |
| | Oxidation reaction temperature | ° C. | 847 | 847 | 847 |
| Material | Minimum required water flow | kg/hr | 104 | 34 | 12 |
| requirements | Minimum required air flow | kg/hr | 323 | 323 | 323 |
| | CoO inventory | kg/hr | 931 | 931 | 931 |
| Energy | Heating demand of the | kWₜₕ | 267 | 220 | 211 |
| demands | reduction reaction | | | | |
| | Pump power consumption | kW | 0.0009 | 0.0003 | 0.0001 |
| | Compressor power | kW | 2.3 | 2.3 | 2.3 |
| | consumption | | | | |
| | Condenser cooling demand^{#} | kWₜₕ | 69 | 23 | 8 |
| Energy | Heat generation of the oxidation | kWₜₕ | 196 | 195 | 194 |
| generation | reaction | | | | |
| and oxygen | Oxygen flow | m³/hr | 50.0 | 50.1 | 50.2 |
| production | Oxygen purity | | 0.96 | 0.96 | 0.96 |

^{#}Potential heat recovery points

These features of copper and cobalt based oxygen carriers are clearly shown in Table 3, where the energy inputs for all examined scenarios were found nearly the same as the energy outputs provided that the produced low-grade waste heat is recyclable. Table 3 shows that for both copper and cobalt based oxygen carriers, the amount of produced low-grade waste heat (originating from the oxygen-water separation process) is greatly reduced and hence there is a lower energy penalty as the oxygen partial pressure of the product stream increases. In addition, a specific power demand of the CL-ESOP unit 70 of about 0.08 kWh/m³ was found to be consistent for all examined scenarios after taking into account the electrical energy demand, the recoverable energy production and any energy losses of the process. This number represents a significant energy discount at about 81-92% when compared with the typical specific power demands of large Cryogenic Air Separation Unit (CASU) units at 0.43-0.55 kWh/m³ of oxygen and small-medium scale Pressure Swing Adsoprtion (PSA) processes at 0.8-1 kWh/m³ of oxygen. However, a detailed economic analysis of the different processes is required to determine the suitability of one process over the other for a particular application.

TABLE 3
Overall performance comparison of the standard CL-ESOP unit 70 using CuO and CoO as the
oxygen carriers

| Parameters | Units | CuO case | | | CoO case | | |
|---|---|---|---|---|---|---|---|
| Oxygen partial pressure | | 0.25 | 0.50 | 0.75 | 0.25 | 0.50 | 0.75 |
| during the reduction | | | | | | | |
| reaction | | | | | | | |
| Reduction reaction | ° C. | 1040 | 1077 | 1102 | 894 | 913 | 925 |
| temperature | | | | | | | |
| Oxidation reaction | ° C. | 950 | 950 | 950 | 847 | 847 | 847 |
| temperature | | | | | | | |
| Electrical/thermal energy | kW(t) | 181 | 135 | 130 | 267 | 220 | 211 |
| demand | | | | | | | |
| Power demand | kW | 2.3 | 2.3 | 2.3 | 2.3 | 2.3 | 2.3 |
| Generated low-grade | | | | | | | |
| waste heat^{#} | | | | | | | |
| Generated low-grade | kWₜₕ | 67 | 23 | 8 | 69 | 23 | 8 |
| waste heat^{#} | | | | | | | |
| Generated medium- | kWₜₕ | 0 | 0 | 0 | 0 | 0 | 0 |
| grade waste heat^{#} | | | | | | | |
| Generated high-grade | kWₜₕ | 112 | 111 | 110 | 196 | 195 | 194 |
| waste heat^{#} | | | | | | | |
| Specific power demand | kWh/m³ | 0.08 | 0.08 | 0.08 | 0.08 | 0.08 | 0.08 |
| of CL-ESOP | | | | | | | |

^{#}The low-grade, medium-grade, and high-grade heat refers to heat produced at temperatures <100° C., 100° C., −600° C., and >600° C., respectively in general.

To meet the various requirements of different industrial sectors, two further embodiments of the invention have been developed to cater to the requirements of pure oxygen injection and oxygen enrichment in air and CO₂.

The inventors also performed a preliminary techno-economic feasibility of the CL-ESOP unit 70 for a full functioning medical hospital of 500 beds having a continuous oxygen demand of 50 m³/h, which requires 2.7 standard CL-ESOP units 70 to be built.

In the off-peak period, it was determined that by assuming a 50% oxygen partial pressure in the reduction reaction and using cobalt oxide as the oxygen carrier (and hence a reaction temperature of 913° C.), the total electrical energy demands of the 2.7 standard CL-ESOP units 70 were 682 kWh at a cost of AUD 92 per hour (assuming 12 cents per kWh of off-peak electricity consumption). During the 9-hour operation of the off-peak period the energy consumption would be 6,138 kWh which costs AUD 736. In addition to the energy demand, the CL-ESOP unit 70 also requires materials supply of a minimum water flow at 92 kg/h and a cobalt oxide flow at 2,482 kg/h. Since water was condensed and recycled in the CL-ESOP process, the net requirement for water is quite low depending on the size of the reactor and the amount of water losses in the process. Moreover, the heat rejection during the oxygen-water separation process in the form of 61 kWₜₕ of low-grade heat can be recycled for hot water generation. This contributes to a natural gas bill saving of ˜AUD 8 per hour (assuming AUD 4 per GJ of natural gas consumption).

During the peak period, an exothermic oxidation of the oxygen carriers takes place, which releases most of the energy consumed/stored during the off-peak period in the form of ˜5490 kWh of high-grade heat. The high-grade heat released was then converted into power using a steam turbine and produced 1827 kW of electricity and another 3663 kWₜₕ of low-grade waste heat. The produced electricity can be used to offset peak period electricity bill and the associated saving is AUD 640 (assuming 35 cents per kWh of peak electricity consumption). The remaining waste heat can also be used to offset natural gas bill in terms of HVAC and hot water applications, which is another saving of ˜AUD 53.

Thus, the net outcome of the preliminary techno-economic analysis for the CL-ESOP unit 70 is a total energy saving of about AUD 693 per day against an energy consumption of AUD 736. Therefore, it can be said that the net oxygen production cost is only AUD 43 per day (or 3.6 cents/m³ of oxygen) for the hypothetical hospital. This is at a significant discount ˜70 to 85% of those of the present oxygen production technologies, namely approximately 12 and 24 cents/m³ of oxygen for cryogenic air separation and pressure swing adsorption technologies, respectively.

In FIG. 1, the intermittent CL-ESOP process employs a single reactor 2 with a manifold to permit gas switching. Thus, instead of shuttling or moving the metal/mineral oxide particles between the two reactors, the gas is switched to enable oxidation and reduction to be alternately performed. This system can be deployed to any process industries, hospitals, buildings and gas companies where high purity oxygen generation is required. The intermittent CL-ESOP process can work as an energy storage and provide heating/cooling/electricity during peak hours operation as well as produce oxygen as a by-product at relatively low cost during off peak hours. The efficiency of the intermittent CL-ESOP process is contemplated to be as high as compressed air energy storage or pumped hydro processes. The major advantages of the intermittent CL-ESOP process are that it (1) can be applied to any scale (e.g. at small scale for hospitals up to at medium-large scale for process industries and gas companies); (2) can produce oxygen at relatively lower cost during night time or off-peak hours and generate additional thermal energy during day time or peak hours to generate heating/cooling/electricity; and (3) can become an option of energy storage at relatively higher efficiency and has zero self-discharge and higher discharge time. In the preliminary techno-economic assessment being carried out recently on the intermittent CL-ESOP system, it was established that 75-95% cost reduction in the oxygen production can be achieved. This suggests that oxygen if produced in intermittent CL-ESOP mode will be nearly free of cost.

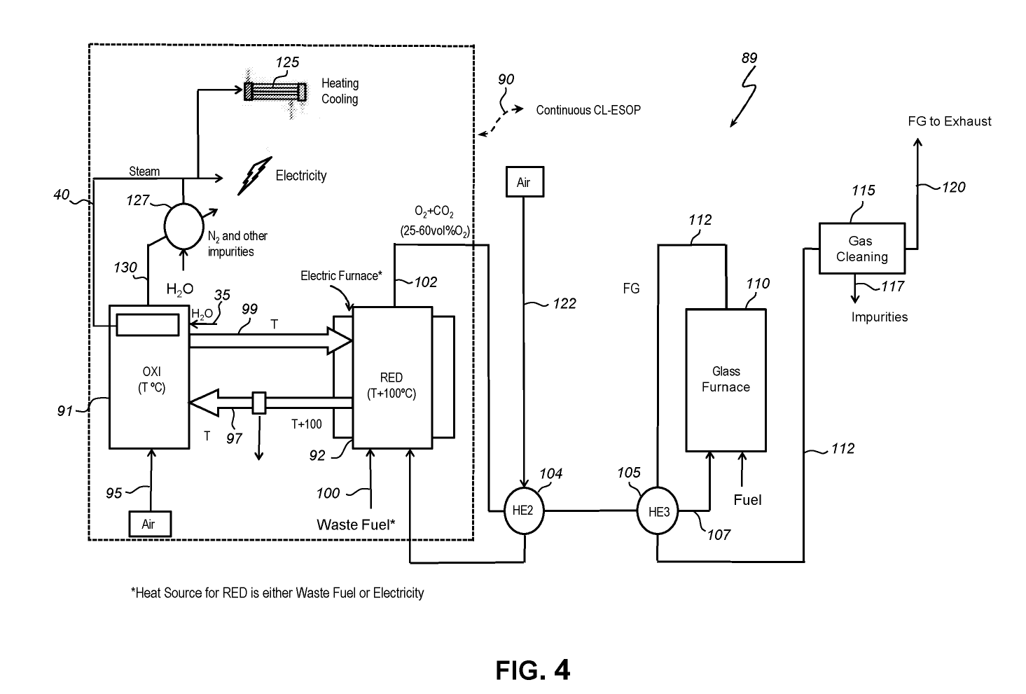

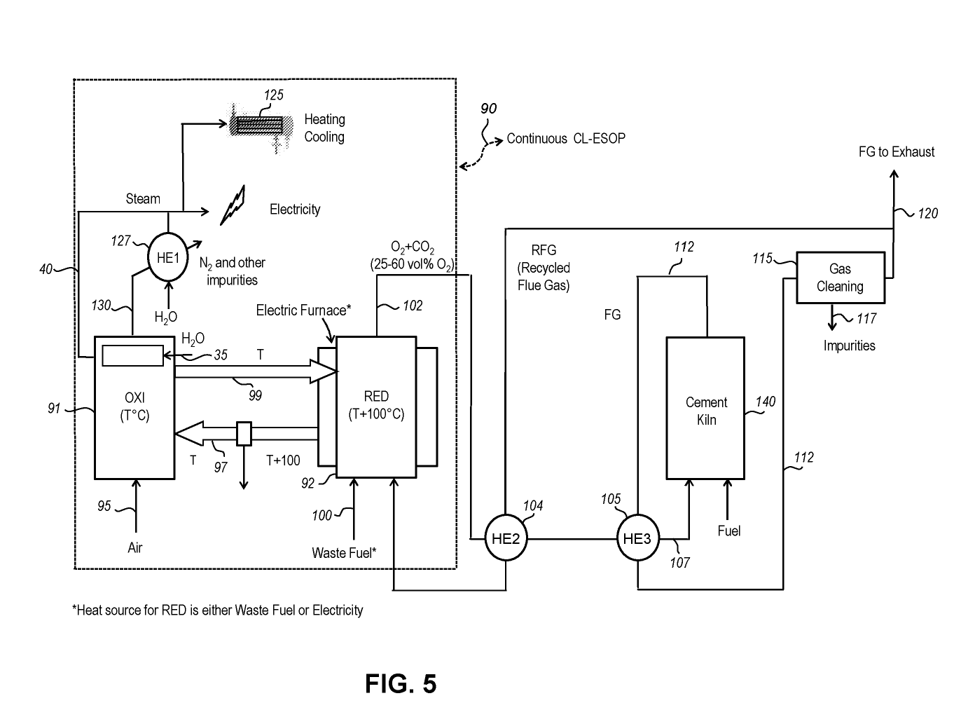

FIGS. 4 and 5 illustrate the other embodiment, which comprises a continuous CL-ESOP process that is suitable for integration with cement kiln and glass melting furnaces for oxygen enrichment with flue gas and air. The continuous CL-ESOP process involves a system 89 that employs a continuous CL-ESOP unit 90 having two fluidised bed reactors 91, 92 linked together through a loop seal (not shown) to prevent gas leakage from one reactor to another. Air is fed at 95 into the oxidation reactor 91 so that the incoming reduced carrier particles at 97 can be regenerated to a higher oxidation state. The regenerated carrier particles, in turn, are transported back at 99 to the reduction reactor 92 where oxygen decoupling occurs in the presence of flue gas (generally comprising carbon dioxide) plus a secondary/waste fuel gas stream 100. The mixture 102 of flue gas and oxygen exiting from the reduction reactor 92 thus will not contain nitrogen and hence can be used directly for oxygen enrichment in various downstream processes.

The mixture 102 is passed through heat exchangers 104, 105 and sent via conduit 107 to a burner in the form of a glass furnace 110. The flue gas from the glass melting furnace 110 is sent along a conduit 112 through the heat exchanger 105 to warm up the mixture 102 and then to a gas cleaning apparatus 115 where impurities are removed at 117 and the remaining flue gas is exhausted to the ambient environment at 120. The heat exchanger 104 uses the mixture 102 to heat up incoming air from a conduit 122.

The heat from the oxidation reactor 91 is used to generate steam from water passing through conduit 35 that is sent via the conduit 40 to generate electricity (by way, for example, of a steam turbine) and waste heat from the turbine can then be used for downstream heating or cooling at 125. Exhaust gases from the oxidation reactor 91 are sent to a heat exchanger 127 via a conduit 130 to further heat the steam from the conduit 40. Nitrogen and other impurities can be removed from the exhaust gases before being discharged into the ambient environment.

Referring to FIG. 5, the continuous CL-ESOP process of FIG. 4 is implemented for a cement kiln 140 instead of a glass furnace. The continuous CL-ESOP system 142 is substantially the same as the continuous CL-ESOP system 89, except that a recycled flue gas (RFG) conduit 145 delivers RFG from the exhaust conduit 120 (after the gas cleaning apparatus 115 ) back through the heat exchanger 104 and then into the reduction reactor 92.

It has been estimated that at least 60-80% cost reduction can be achieved with continuous CL-ESOP system 89. In addition, extensive experimental and modelling work has been carried out to evaluate the feasibility of the continuous CL-ESOP processes described above at different scales. This work indicates that continuous CL-ESOP has the lowest energy footprint and hence the lowest oxygen production costs amongst the suit of the technologies available to date.

The inventors consider that what differentiates the CL-ESOP process from conventional and emerging air separation technologies are its simplicity; inexpensive manufacture; ease of integration into existing processes and apparatuses; its low energy demand; and its very high energy efficiency. This is partly due to the fact that the theoretical net heat released over reactions (1) and (2) is zero. The only technical challenge in the CL-ESOP process is that by running the oxidation reactor (i.e. exothermic reaction) at lower temperatures than the reduction reactor (i.e. endothermic reaction), the heat generated at low temperatures in the oxidation reactor cannot be transferred to the reduction reactor being operated at higher temperature. Therefore, the reduction reactor may require additional energy input. However, by running the reduction reactor in auto-thermal mode, an energy vector can be created from the reduction reactor to the oxidation reactor which allows additional energy generation in the oxidation reactor. This energy can be used to generate heating, cooling or electricity. With such additional energy generation from oxidation reactor in intermittent CL-ESOP process, peak demand of the industry can also be served efficiently. The continuous CL-ESOP process will be continuously releasing energy in oxidation reactor which can be used heating, cooling or electricity generation.

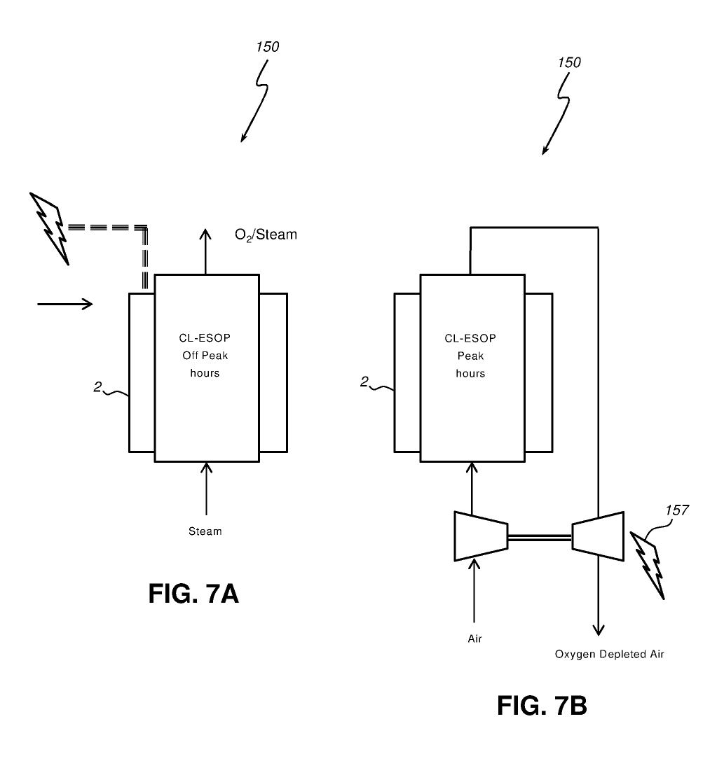

In a further embodiment of the invention, the CL-ESOP process can be applied to a coal-fired power generation plant. The embodiment addresses the challenge of variable load management with the vision to establish a new coal-fired power plant concept that, in addition to baseload production, can robustly and effectively control variable generation without necessarily exposing coal-fired generation units to cycling. This is achieved by integrating a CL-ESOP unit 150 (which is similar to the CL-ESOP units as described above) according to one embodiment of the invention with coal-fired power generation. In this configuration, as shown in FIG. 7, the CL-ESOP unit 150 stores the low cost thermal and electric energy generated by the coal fired power plant during an off-peak period 152 (for example, between 8 pm and 8 am), in which the reduction process is performed by the CL-ESOP unit. The CL-ESOP unit 150 then releases the same quantity of energy back to the grid during peak hours 155 (for example, between 8 am and 8 pm), in which the oxidation process is performed by the CL-ESOP unit. With this approach, coal-fired units of the power plant will provide the baseload and, hence, are not subjected to cycling while the CL-ESOP unit 150 deals with the variable load and essentially functions as a peak demand energy unit.

In a particularly preferred embodiment, the CL-ESOP unit 150 is tailored for energy storage and retrofitting to coal-fired power plants. Distinctive features of the CL-ESOP process in this embodiment include prolonged redox half-cycles (reduction for one half cycle and oxidation in the other half cycle) and the use of single manifold switching reactor instead of twin reactor configuration typically used in CLAS.

The concept of CL-ESOP as applied to coal-fired power generation is schematically shown in FIGS. 7A and 7B. Unlike CLAS, which uses a dual circulating fluidised bed design, the CL-ESOP unit 150 uses a single reactor 2 which is operated in a manifold gas switching manner. In this embodiment, instead of water, the hot air is used for heat extraction. Manifold gas switching is the same as explained in FIG. 1 where a single reactor is used and gas is switched between the oxidation and reduction cycles. During off peak hours the CL-ESOP unit 150 reduces the sorbents using electricity 157 from a power plant, as best shown in FIG. 7A. In peak hours the CL-ESOP unit 150 oxidises the sorbents and regenerates electricity 157, as best shown in FIG. 7B. According to preliminary calculations, it is expected the CL-ESOP unit 150 will be able to reduce around 15-30% greenhouse gas emissions during the off peak period, which corresponds to the night phase. Also, along with the reduction in the energy wastages during the night phase, the CL-ESOP unit 150 generates oxygen as a by-product which then can be sold as a product or used to convert coal-fired power plant to a low emission oxy-fuel station.

Also, a unique pressure-temperature (PT) swing approach is adopted during the reduction-oxidation process to reduce the environmental footprint. In this unique pressure-temperature swing approach, oxidation and reduction reaction cycles are operated at a different pressures and temperatures in order to improve the energy efficiency in both cycles. Thus, by increasing the temperature, for example, the equilibrium constant will shift from oxidation to reduction. Conversely, reducing the temperature, the equilibrium constant will shift back to oxidation from reduction. Thus, operating the CL-ESOP unit 150 at higher temperatures will result in reduction while operating the CL-ESOP unit 150 at lower temperatures will result in oxidation. A similar effect occurs for changes in pressure-operating the CL-ESOP unit 150 at lower pressures will result in reduction while operating the CL-ESOP unit 150 at higher pressures will result in oxidation. Hence, the equilibrium constant shifts in response to changes in the operating pressure or temperature. Thus, by changing the temperature or pressure, the CL-ESOP unit 150 can controlled to selectively perform reduction or oxidation, as desired. . In this way, the CL-ESOP unit 150 can operated in the most efficient manner to alternately perform both oxidation or reduction reactions, depending on which reaction is required.

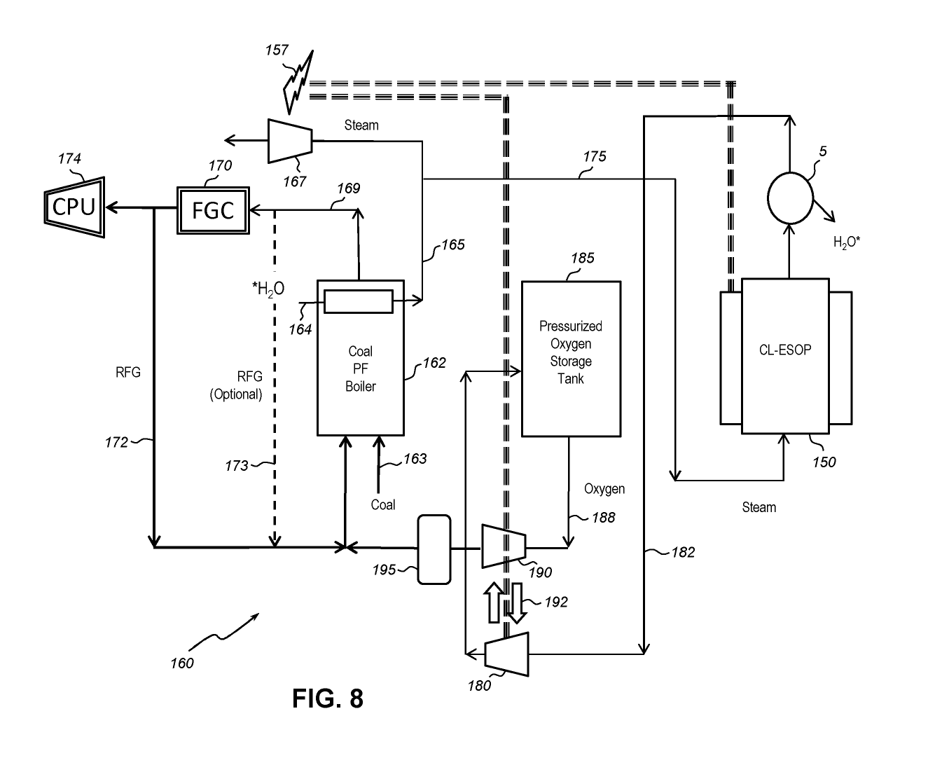

Referring to FIG. 8, the CL-ESOP unit 150 is shown in operating in a night (off-peak) phase for a coal-fired power plant 160 to transform it into an oxy-fuelled power plant. The coal-fired power plant 160 comprises a coal fired PF (pulverized fuel) boiler 162 that receives coal at 163 to generate heat that converts water 164 introduced by a conduit 165 into steam that is sent to a steam turbine 167 for generating electricity at 157. The flue gas from the boiler 162 is sent via a conduit 169 to a flue gas cleaner 170, after which it is recycled by a conduit 172 back to the boiler 162. The flue gas is optionally recycled by a conduit 173 instead of going to a flue gas cleaner. The remaining gas from the flue gas cleaner 170 is then sent to a CPU (CO₂ processing unit) 174.

The steam converted from the water by the boiler 162 is also directed via a conduit 175 to the CL-ESOP unit 150, which is performing the reduction process since it is in the night phase. The reduction process generates the oxygen-enriched stream from which oxygen is separated from water in the condenser 5. The oxygen produced by the CL-ESOP unit 150 then passes to a heat exchanger 180 via a conduit 182 and is then stored under pressure in a storage tank 185.

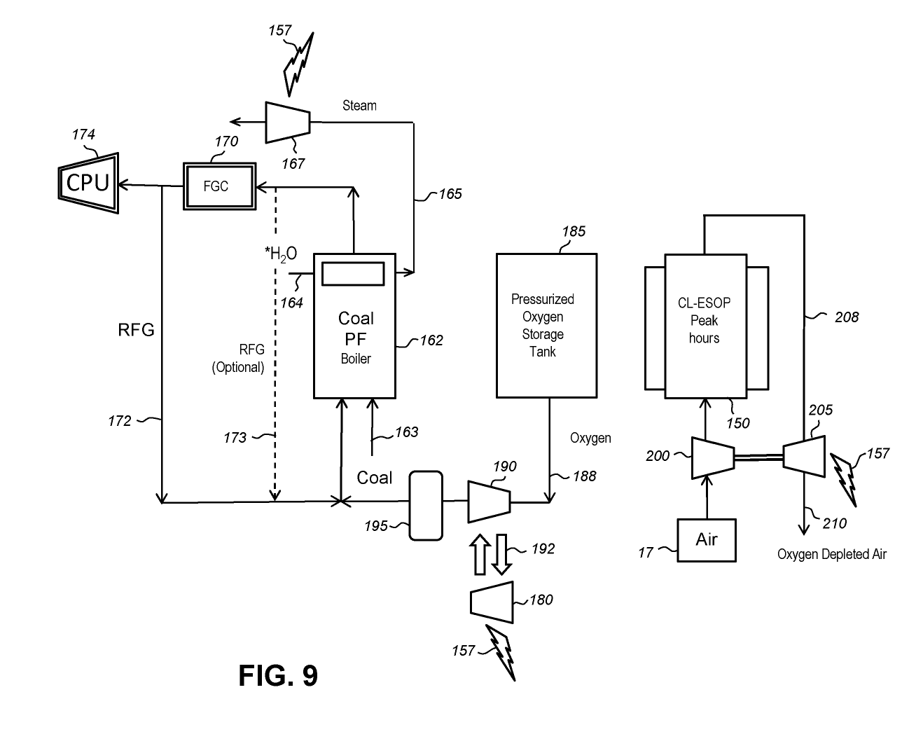

Referring to FIG. 9, the CL-ESOP unit 150 is shown in operating in a day (peak) phase with the coal-fired power plant 160. When required, the oxygen is controllably released from the storage tank 185 via a valve (not shown) and sent via a conduit 188 through a heat exchanger 190 to transfer heat at 192 with oxygen from the CL-ESOP unit 150 and held in a reservoir 195. The oxygen then moves from the reservoir 195 via a valve (not shown) and combines with the recycled flue gas from conduits 172, 173 and coal 163 to fuel the boiler 162, thus creating an oxy-fuelled power plant. The electricity 157 generated can be used to power the CL-ESOP unit 150 and the heat exchangers 180, 190. In particular, the oxygen is expected to be released during high or peak demand periods where the baseload produced by the coal-fired power plant 160 cannot meet this extra demand. Hence, the oxygen can be released from the storage tank 185 when required to meet this demand, improving the efficiency of the power plant 160 and avoiding the potential damage caused when forcing the boiler 162 into sub-optimal operation to meet cycling requirements or the additional costs in using an electrically driven turbine to generate the additional electricity required to meet demand during these peak periods. Thus, the CL-ESOP unit 150 results in less wear on the boiler 162, reduces maintenance costs and increases the life expectancy of the boiler 162.

The CL-ESOP unit 150 in the day phase performs the oxidation process to regenerate the oxygen-depleted oxygen carrier particles in the fluidised bed. To do so, air from an air supply 17 that is passed through a turbine 200 and then into the CL-ESOP unit 150. Oxidation replenishes the oxygen carrier particles so that they are ready for use in the reduction process that takes place in the CL-ESOP unit 150 during the night phase. A conduit 208 then removes the oxygen-depleted air (i.e. reduced air) from the CL-ESOP unit 150 and passes it through a turbine 205 to generate electricity 157 before being discharged through an outlet 210 into the ambient environment.

It can thus be observed that by operating the CL-ESOP unit 150 to perform reduction and oxidation processes continuously in separate predetermined time periods, the invention enables the efficient production of oxygen for use by the coal-fired power plant 160. Moreover, by making the predetermined time periods coincide with peak and off-peak periods of demand, this efficiency in oxygen production and resultant energy storage is maximised.

The working principle of CL-ESOP process is extremely straightforward and can be explained with the redox reaction of mono- or bi-metallic oxide/composite sorbents (i.e. highly exothermic oxidation during peak hours and endothermic reduction during off-peak period). While storing energy during off-peak period, the CL-ESOP process can also produce oxygen which then can be stored and sold as a value added product in the case of conventional coal-fired power plant (as described in the above embodiments) or alternatively used in-house in the case of more advanced coal-fired power plants such as oxy-fuel plants which require oxygen.

By integrating the CL-ESOP process of the invention with an existing coal fired power plant provides numerous advantages and benefits, including:
It provides an excellent opportunity to the existing coal-fired power plants to serve as a load following/peaking plant together with baseload without exposing their coal-fired units to cycling. This in turn minimises the periods of suboptimal operation and, thereby, improves efficiency and lowers greenhouse gas emissions.
It can reduce electricity waste during night time and utilizes this low cost thermal and electrical energy for energy storage as well as oxygen production.
If retrofitted to oxy-fuel type plants the energy penalties associated with oxygen production can be minimized significantly.
Considering higher projected natural gas price in Australia in the near future, the CL-ESOP system will be extremely competitive against natural gas engine and turbine power plants for catering load following/peak demands.
The CL-ESOP system will have extremely high efficiency, zero self-discharge and very high discharge rate and time which are typically better than those of batteries and fuel cells and equivalent to pumped hydro and compressed air energy storage system.
The CL-ESOP hardware is also very simple and comprises a single reactor with manifold gas switching option. Due to simplicity involved in the reactor hardware and operation, the CAPEX and OPEX required for CL-ESOP is estimated to be extremely low.
CL-ESOP will also have wide applications in clean coal and biomass combustion, gasification and pyrolysis processes.

It is preferred that the oxidation reactor in the above embodiments operates at atmospheric pressure and at temperatures between 750° C. and 1050° C. Likewise, it is preferred that the reduction reactor in the above embodiments operates at pressures between 1 bar and 100 bar and temperatures between 600° C. and 1100° C.

While the preferred embodiments have been described in relation to combustion units like the boiler of a coal-fired power plant and a glass melting furnace in a glass making plant, it will be appreciated that the invention is readily used with other industrial units and processes that use oxygen, including oxy-fuelled furnaces, cement kilns, electric arc furnaces, oxygen enrichment processes, glass melting furnace and blast furnaces in steel making plants. Moreover, the invention may also be implemented in conjunction with renewable energy sources, such as being integrated with solar or geothermal energy sources. For example, the invention may be connected to a solar photovoltaic panel system so that during the day phase, the additional electrical energy is used to generate and store oxygen instead of being returned to the electricity grid, and in the night phase, electricity can be generated from the stored oxygen. Similar principles apply to off-peak demand/peak demand periods instead of simply day/night periods. It is also contemplated that the invention is also equally applicable to the other industries, such as the steel making, glass making, petrochemical, wastewater and chemical industries where oxygen is required in the chemical process.

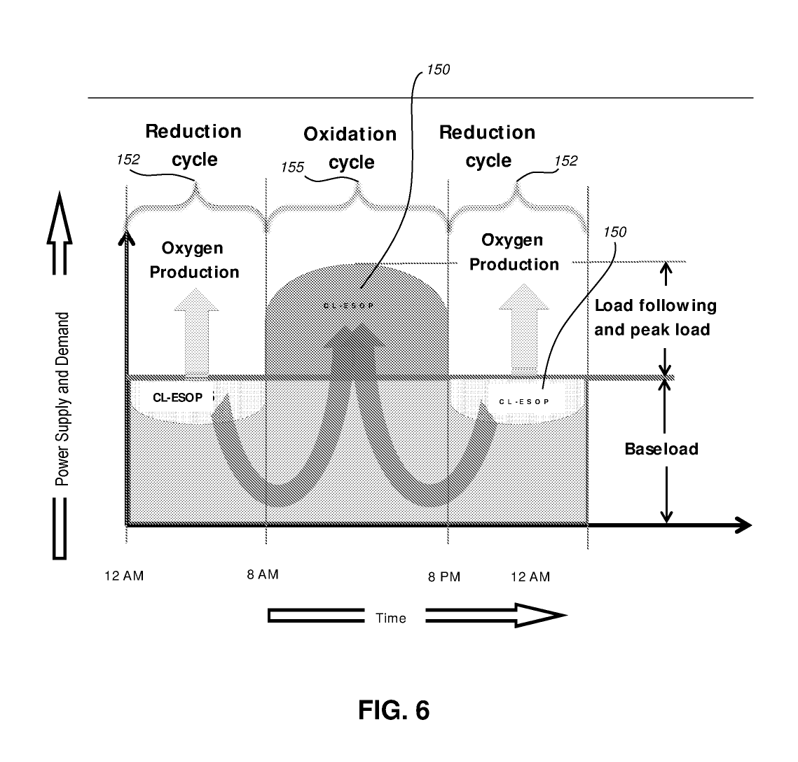

It will further be appreciated that any of the features in the preferred embodiments of the invention can be combined together and are not necessarily applied in isolation from each other. For example, the feature of recycling flue gas conduits 172, 173 in FIGS. 8 and 9 can be used in the system of FIG. 6, where a suitable flue gas recycling conduit may be used return flue gas to the glass furnace 110. Similar combinations of two or more features from the above described embodiments or embodiments of the invention can be readily made by one skilled in the art.

By providing a method and system where oxidation and reduction processes are performed alternately and in separate time periods or phases, the invention enables the generation of oxygen and storage of energy in an efficient manner that reduces energy costs (in terms of oxygen production and usage of electricity to operate) and environmental (greenhouse gas) impacts. The regeneration of the oxygen carrier particles involves less cost and is performed efficiently during the night or off-peak period. Moreover, when applied to coal-fired power generation, the invention enables the existing plants to only provide baseload power generation while the process provides additional load to meet demand during peak periods. This reduces or prevents damage to the power generation units in the plant especially when using cycling principles and so reduces maintenance costs, minimises power generate unit failure and life expectancy. All these advantages of the invention result in improved efficiencies in energy use and thus overall reduced costs (capital and operating costs) to industrial and medical applications requiring the use of oxygen. Furthermore, since the invention involves a modular unit, the invention can be readily implemented to existing power plants, combustion-based units and other industrial or medical process units consuming oxygen. In all these respects, the invention represents a practical and commercially significant improvement over the prior art.

Although the invention has been described with reference to specific examples, it will be appreciated by those skilled in the art that the invention may be embodied in many other forms.

1. A method for producing oxygen, comprising:
transferring oxygen-carrier particles between a reduction process and an oxidation process connected to form a chemical looping process, wherein the reduction process produces oxygen-depleted carrier particles and an exhaust gas mixture comprising oxygen;
removing the exhaust gas mixture from the reduction process;
separating oxygen from the exhaust gas mixture; and
returning the oxygen-depleted carrier particles to the oxidation process for regenerating the oxygen-depleted carrier particles with oxygen;
wherein the reduction process is performed during a first time period and the oxidation process is performed in a second time period.

2. The method of claim 1, wherein the first time period comprises a day phase.

3. The method of claim 2, wherein the day phase comprises a 12-hour period or a 15-hour period.

4. (canceled)

5. The method of claim 1, wherein the first time period comprises a peak oxygen-demand period.

6. The method of claim 1, wherein the first time period comprises a peak energy demand period.

7. The method of claim 1, wherein the second time period comprises a night phase.

8. The method of claim 7, wherein the night phase comprises a 9-hour period or a 12-hour period.

9. (canceled)

10. The method of claim 1, wherein the second time period comprises an off-peak oxygen-demand period.

11. The method of 6 claim 1, wherein the second time period comprises an off-peak energy demand period.

12. The method of claim 1, further comprising adding an oxygen-containing gas to the oxidation process to enrich the oxygen-depleted carrier particles with oxygen.

13. The method of claim 1, wherein the separating step comprises condensing the oxygen from the exhaust gas mixture.

14. The method of claim 1, wherein the oxidation and reduction processes occur within one reactor.

15. The method of claim 1, wherein the oxidation process occurs in an oxidation reactor and the reduction process occurs within a reduction reactor, where the oxidation reactor and the reduction reactor are fluidly connected to form the chemical looping process.

16. Use of a reactor in the method of claim 1.

17. A system for producing oxygen, comprising one or more reactors for performing an oxidation process and a reduction process connected to form a chemical looping process, wherein the reduction process produces oxygen-depleted carrier particles and an exhaust gas mixture comprising oxygen; a conduit for removing the exhaust gas mixture from the reactor; a an oxygen separating unit for separating oxygen from the exhaust gas mixture; wherein the one or more reactors are configured to perform the reduction process during a first time period and perform the oxidation process in a second time period.

18. The system of claim 17, further comprising a heat exchanger for exchanging heat between the exhaust gas mixture and incoming gas into the reactor for the reduction process.

19. The system of claim 17, further comprising a heat exchanger for exchanging heat between air from an air supply and oxygen depleted air from the reactor generated by the oxidation process.

20. The system of claim 17, further comprising a reservoir for storing the oxygen from the oxygen separating unit.

21. The system of claim 20, wherein the reservoir controllably releases oxygen to a combustion unit.

22. The system of claim 21, wherein the combustion unit combusts coal in a coal-fired power plant.

23. (canceled)
